(19) United States
(12) Patent Application Publication
(10) Pub. No.: US 2024/0279467 A1
(43) Pub. Date: Aug. 22, 2024

(54) LOW DENSITY ROOM TEMPERATURE VULCANIZABLE POLYSILOXANE RUBBER COMPOSITION COMPATIBLE WITH HIGH-RESOLUTION MOLDING OPERATIONS

(71) Applicant: Lawrence Livermore National Security, LLC, Livermore, CA (US)

(72) Inventor: James Lewicki, Oakland, CA (US)

(21) Appl. No.: 18/111,397

(22) Filed: Feb. 17, 2023

(51) Int. Cl. C08L 83/04; C08G 77/08; C08G 77/20; C08J 9/228; C08K 3/36

(52) U.S. Cl. CPC C08L 83/04; C08G 77/08; C08G 77/20; C08J 9/228; C08K 3/36; C08J 2203/22; C08J 2383/07; C08L 2312/08

(57) ABSTRACT

A composition of a resin for room temperature vulcanizable rubber includes a polysiloxane with vinyl and/or silanol reactive functionality of at least 2, a crosslinker reactive toward vinyl and/or silanol functionality, polymer microballoons, and a thixotropic additive.

This invention was made with Government support under Contract No. DE-AC52-07NA27344 awarded by the United States Department of Energy. The Government has certain rights in the invention.

### FIELD OF THE INVENTION

The present invention relates to injection and transfer molding operations, and more particularly, this invention relates to a low density, room temperature vulcanizable polysiloxane rubber composition compatible with high resolution molding operations.

### BACKGROUND

Room temperature vulcanizable (RTV) silicone compositions having a reactive, neutral cure at room temperature are well known for forming a solid rubber. The components of the silicone composition, e.g., Component A being a base component, Component B being a curative component, and Component C being a catalyst component, in combination or separate are combined to yield a mixture having a defined work-time, gel-time, and cure time to form a solid rubber. Further, foamed RTV rubber composition having stochastic, open or closed cell-type foams are formed with a blowing agent or pore-former (gas, microballoon, sacrificial particle, etc.) added to the reactive mixture.

However, for closed cavity injection molding operations, where a uniform low density foam fill is used, reactive blowing agent schemes are difficult to implement and control. These low density foam fill compositions yield non-uniform densities and the process is poorly controlled. Moreover, for forming closed-cell type foams, sacrificial pore formers are unsuitable due to the inability to dissolve and/or remove the pore-former, post-cure from the filled mold or cavity. It is consistently difficult to form a rubber material for closed cavity injection or transfer molding operations having a density less than 1 gram per cubic centimeter (g/cc).

A material is needed that is readily injection moldable into a large, fairly complex, closed cavity, and where the closed cavity may have sharp edges and corners. Conventional methods of forming low density rubber require a reactive composition that results in the production of gases. For example, some methods of forming a form uses a reactive composition including a blowing agent such as urethane that results in the production of carbon dioxide (CO2) generated from the reaction of isocyanates with water. For preferred applications, a RTV composition would not have a reactive component that would produce gases. Reactive gas generation mechanisms have to be finely balanced such that the rate of peak blowing is followed closely by the gelation of the rubber network. If the blowing reaction is too slow with respect to crosslinking, then only a few pores are formed. If the rate of blowing agent generation is too fast with respect to gelation, then poor pore formation will again occur. As such all reactive blowing RTVs blow and gel quickly usually within minutes, thereby reducing the stable work-time for a successful injection in a large complex. For many cases, the work-time is too short to be practical. Moreover, “free” gas bubbles formed in a reactive composition are unstable and have the propensity to nucleate, collapse, and coalesce in a reactive composition.

A further complexity arises when a reactive composition is being injected into a complex multi-surfaced form. The leading edge fluid surface will tend to lose bubbles and ‘skin’ but due to the complex mixing of the fluid as it fills a complicated geometry these high density fronts will be folded into other areas of the bulk resulting in density variation. Furthermore, contact of the reacting fluid with walls can cause either additional nucleation of gas or again bubble collapse resulting in further sources of density variation and inhomogeneity. Thus, it is desirable to that the RTV compositions does not have a reactive component that could produce gases.

Preferably, the material has a homogenous density throughout the structure with uniform porosity. For example, a material having a heterogeneous composition of big cells and small cells is not desirable. Uncontrolled heterogeneity in a foam leads to uncontrolled variations in density and unpredictable non-ideal mechanical response.

Non-reactive pore formers (e.g., microballoons, microspheres, etc.) therefore present themselves as an attractive alternative to achieving sub 1 g/cc density silicone RTV foams for closed cavity injection operations. Extant examples of these systems include modifications of commercial silicone neutral cure RTV two component systems, such as Sylgard 184™ (Dow Chemical) with glass microspheres (3M Corporation) to yield compositions with bulk densities of ˜0.7 g/cc. Practically, the limitations of such compositions are limited to a lower density floor of ˜0.50 g/cc, based on the minimum bulk density of the microballoons and the allowed packing fraction. Additionally, as balloon loadings begin to exceed loadings of 55 volume % the flowability of a composition based on typical ˜1500-3000 Cp viscosity silicone resins are greatly diminished and materials rheologically resemble pastes, rather than pumpable, conveyable fluids.

An additional limitation of glass balloon filled silicone compositions is the relative fragility of the microballoons themselves and at (particularly, but not limited to) high volume fraction loadings, the glass microspheres are subject to fracture, breaking and collapse during mixing, processing, and casting operations leading to actual densities higher than calculated and unwanted density variability in the final product.

### SUMMARY

According to one embodiment, a composition of a resin for room temperature vulcanizable rubber includes a polysiloxane with vinyl and/or silanol reactive functionality of at least 2, a crosslinker reactive toward vinyl and/or silanol functionality, polymer microballoons, and a thixotropic additive.

According to another embodiment, a product includes a material comprising a rubber, where the material has a homogenous density and a uniform porosity. The density of the material is less than 1 gram per cubic centimeter (g/cc).

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of components of a resin, according to one embodiment.

FIG. 2 is a schematic drawing of the curative chemistry of the components of the resin, according to one embodiment.

FIG. 3 is a method of forming a room temperature vulcanizable rubber, according to one embodiment.

FIG. 4A is a plot of shear stress versus viscosity of a resin.

FIG. 4B is a plot of shear stress versus viscosity of a series of resin having variable loadings of polymer microballoons, according to one embodiment.

FIG. 5A is a plot of the change in viscosity of a resin during curing, according to one embodiment.

FIG. 5B is a plot of the change in viscosity of the resin in the plot of FIG. 5A in the first 100 minutes of curing, according to one embodiment.

FIG. 6 is a plot of storage modulus/loss modulus as a means of determining gel time of a resin, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm+1 nm, a temperature of about 50° C. refers to a temperature of 50° C.±5° C., etc.

A nanoscale, nanoporous, etc. is defined as having a diameter or length (e.g., a pore having an average diameter) less than 1000 nanometers (nm). A microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

In addition, the present disclosure includes several descriptions of a “resin” used in an additive manufacturing process to form the inventive aspects described herein. It should be understood that “resins” (and singular forms thereof) may be used interchangeably and refer to a composition of matter comprising a plurality of oligomers, particles, small molecules, etc. coated with and dispersed throughout a liquid phase. In some inventive approaches, the resin may be optically transparent having a greater than 90% transmittance of light.

The following description discloses several preferred embodiments of a composition for forming a room temperature vulcanizing rubber and/or related systems and methods.

In one general embodiment, a composition of a resin for room temperature vulcanizable rubber includes a polysiloxane with vinyl and/or silanol reactive functionality of at least 2, a crosslinker reactive toward vinyl and/or silanol functionality, polymer microballoons, and a thixotropic additive.

In another general embodiment, a product includes a material comprising a rubber, where the material has a homogenous density and a uniform porosity. The density of the material is less than 1 gram per cubic centimeter (g/cc).

A list of acronyms used in the description is provided below.

| | |
|---|---|
| 3D | three-dimensional |
| C. | Celsius |
| cSt | centistokes |
| cP | centipoise |
| F | functionality |
| g/cc | gram per cubic centimeter |
| Mn | molar mass |
| ms | millisecond |
| nm | nanometer |
| PDMS | polydimethylsiloxane |
| Pt | platinum |
| RT | room temperature |
| RTV | room temperature vulcanizable |
| Si—H | silane functional group |
| μm | micron |
| V | vinyl functional group |
| vol. % | volume percent |
| wt. % | weight percent |

In applications using light weight rubber material, e.g., light weighting, thermal, acoustic installation, damping, etc. it is desirable to have less dense material, e.g., a density less than 1 g/cc. In current applications, formation of a rubber material having a density less than 1 g/cc typically includes increasing the of amount of pore-former to achieve the desired density; however, in so doing, the increased amount of pore-former transforms the resin into an un-flowable composition. For example, pore formers such as glass microballoons have a density of 0.11 g/cc, so to achieve a resin having a density of 0.5 cc/g resin from an original resin density without pore former of 1 g/cc, an amount of glass microballoons would be added that creates a paste-like composition rather than a desired fluid-like composition. In sharp contrast, as described herein, polymer microballoons having a density as low as 0.02 g/cc function to lower the density of a flowable resin formulation.

Moreover, commercial grade silicone resins, e.g., Sylgard 184™ (Dow Chemical Company) combined with polymer microballoon pore formers does not necessarily result in an optimal or even a useable injection molding product for at least the following reasons. First, the viscosity of the commercial resin transitions to a nonflowing paste at moderate pore former loadings. Second, a density mismatch between the microballoons and the resin may cause a partial or whole phase segregation of the microballoons and the resin during post injection operations and prior to gelation, thereby resulting in a non-uniform density part.

According to one embodiment, a composition of a resin includes a polysiloxane and a stable pore-former for forming a rubber foam using molding techniques, such as injection and transfer molding, where the composition provides sufficient and uniform gap fill and high resolution. Silicones, polymers comprised of siloxane (polysiloxane), are relatively well-known as rubbers that are good for encapsulation, good for gap fill, high resolution, etc. because polysiloxane compositions tend to flow well. A pore former may be added to the polysiloxane composition in order to lower the density of the composition and achieve a desired low density of less than 1 g/cc.

According to one embodiment, a composition of a resin for RTV rubber includes a polysiloxane with vinyl and/or silanol reactive functionality of at least two, a crosslinker reactive toward vinyl and/or silanol functionality, polymer microballoons, and a thixotropic additive for bridging the polysiloxane with the polymer microballoons. According to one approach, a combination of a polysiloxane with polymer microballoons provides a formulation having a liquid composition with a low density. The density may be tuned by changing the loading of the polymer microballoons. In a preferred approach, the composition comprises a custom formulated extreme low viscosity reactive silicone resin base modified with a temperature dependent thixotrope and modified catalyst package.

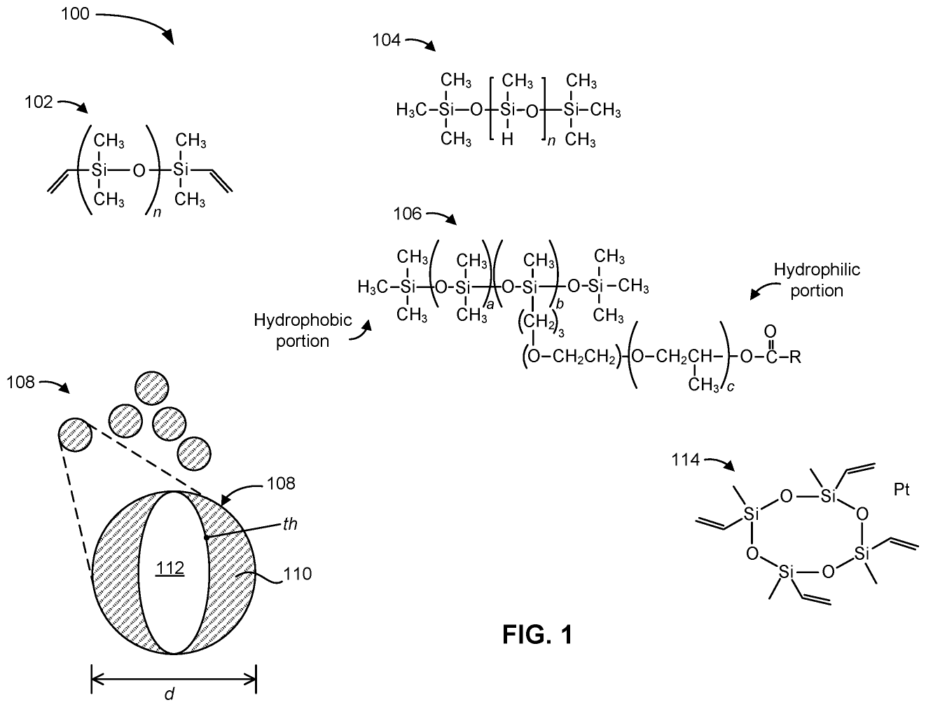

FIG. 1 depicts a schematic diagram of components of a composition 100, in accordance with one aspect of an inventive concept. As an option, the present composition 100 may be implemented in conjunction with features from any other inventive concept listed herein, such as those described with reference to the other FIGS. Of course, however, such composition 100 and others presented herein may be used in various applications and/or in permutations which may or may not be specifically described in the illustrative embodiments listed herein. Further, the composition 100 presented herein may be used in any desired environment.

In one example, the composition 100 of a resin for a RTV rubber includes a polysiloxane 102, a crosslinker reactive toward vinyl and/or silanol functionality, such as a silane crosslinker 104, and a thixotropic additive 106. As illustrated, the polysiloxane 102 may be vinyl terminated polydimethylsiloxane (PDMS) having a functionality of about 2 (F=2). The silane crosslinker 104 may be a polymethylhydrosiloxane crosslinker having a functionality of 3 or greater. The composition 100 may also include a thixotropic additive 106 such as an amphoteric polyether, e.g., a silicone polyether.

In various approaches, the polysiloxane may include at least one of the following polysiloxanes: a vinyl-terminated polysiloxane, a thiol-ene terminated polysiloxane, a dimethyl siloxane, a di-phenyl siloxane, an ethyl, methyl siloxane, a diethyl siloxane, a tetra-functional polysiloxane, a tri-functional polysiloxane, etc. In some approach, two or more different polysiloxanes may be combined in copolymer form, for example, a polydimethylsiloxane(PDMS)-polyvinylmethylsiloxane copolymer. In some approaches, a combination of polysiloxanes may be included in the composition. Preferably, the polysiloxane has a low molar mass. In some approaches, the molar mass Mn of the polysiloxane is in a range of greater than 200 g/mol up to about 10,000 g/mol. In one example, the molar mass of a vinyl terminated PDMS resin is approximately 6000 g/mol having a F=2.

In various approaches, the crosslinker may be a silane crosslinker having at least three silane functional groups. In various approaches, the silane crosslinker may be any form of silane crosslinker, e.g., a trisilane crosslinker, a tetrasilane crosslinker, etc. The silane crosslinker may be an oligomeric polysiloxane crosslinker. The functionality of the silane crosslinker is preferable three or greater. In one example, the silane crosslinker is a polymethylhydrosiloxane crosslinker having a functionality of 41. Preferably, the silane crosslinker has at least three functional silane groups. The molar mass Mn of the silane crosslinker may be in a range of 1700 to 3200 g/mol.

In one approach, a composition of the resin may include a vinyl silicone and a thiol and/or thiolene crosslinker having at least three functional groups. The crosslinking reaction preferably includes heat to drive the crosslinking reaction. In another approach, a composition of the resin may include a silanol-terminated siloxane and an alkoxy blocked multi-functional silane crosslinker. For example, the alkoxy blocked silane may be tetraethoxysilane. The catalyst for the crosslinking reaction includes an organo-tin catalyst.

According to one embodiment, the composition of a low density RTV resin includes a low density poreformer such as polymer microballoons. An example of a low density pore-former is self-blown acrylate polymer microballoons.

In some approaches, polymer microballoons may be obtained as unexpanded microballoons. In a preferred approach, the polymer microballoons are obtained as expanded microballoons, where the polymer microballoons are pre-expanded in order to avoid any active reaction of the pore former in situ. For example, an unexpanded microballoon contains a blowing agent, such as a gas, inside a thermoplastic shell. The blowing agent is a gas, such that heating the thermoplastic shell above the glass transition temperature of the shell material causes the gas under pressure to blow a bubble (gas blowing agent) and expand within the expandable thermoplastic shell. The thickness of the thermoplastic shell may decrease from about 2 μm to 0.01 μm as the diameter of the microballoon expands from 12 μm to about 40 μm, respectively. Cooling the shell to a temperature below the glass transition temperature of the shell material sets the thermoplastic shell to the new expanded shape. The expanded polymer microballoons demonstrate robust integrity such that under applied pressure, the microballoons may be deformed, squished, flattened, etc. and returned to their original shape after applied pressure is removed. The microballoons demonstrate resistance to cracking, breaking, etc. under high shear mixing. In sharp contrast, glass microballoons shatter, crack, disintegrate, etc. under similar process conditions having high shear mixing.

In one approach, the composition 100 includes polymer microballoons 108 which may be included as a component of the resin before addition of a catalyst. Polymer based microballoons offer an advantage both in process survivability and ultimate achievable density versus commercial glass microspheres. The composition is capable of accepting loadings of polymer microballoons sufficient to produce a cured bulk rubber with densities as low as 0.3 g/cc, which remains compatible with high resolution injection molding processes. Loadings may be achieved primarily using the custom, low viscosity base resin.

The polymer microballoons 108 in FIG. 1 illustrate a magnified view of one polymer microballoon 108 (a portion has been removed to view the center of the microballoon) that includes a thermoplastic shell 110 where the microballoon 108 is filled with a blowing agent 112. The polymer microballoons are expanded gas-filled microballoons having a thermoplastic shell. In the expanded state, the thickness th the thermoplastic shell 110 may be around 0.1 μm. The blowing agent 112 may be gas that allows the polymer microballoon 108 to be expanded before use. The polymer microballoons are preferably added to the resin in an expanded state. In some approaches, a polymer microballoon may be heated to allow the blowing agent to expand up to 60 times its original volume.

Preferably, the pore former has a high volume to weight ratio (g/cc), such as in a range of less than 0.1 g/cc to about 0.02 g/cc. For example, the pore former has a larger volume per mass, has a low density, etc. In exemplary approaches, pre-expanded polymer microballoons have a density in a range of greater than 0.01 g/cc to less than 0.5 g/cc. Pre-expanded polymer-based microballoons (e.g., microspheres) may be obtained commercially, such as Expancel® Thermoplastic Microspheres from Nouryon (Fort Worth, TX) at bulk densities as low as 0.017 to 0.023 g/cc.

The density of the polymer microballoons may be selected according to the application of the rubber product and the desired density of the rubber product. Polymer microballoons may be selected according to the distribution of sphere size, e.g., a bimodal distribution, a trimodal distribution, etc. that provide a range of densities of the polymer microballoons. The sphere size is determined by an average diameter d of the microballoons (as illustrated on the microballoon 108 of FIG. 1), preferably, the average diameter d of the microballoons may be in a range of about 40 to about 100 μm. In an exemplary approach, the average diameter d of the microballoons may be in a range of about 40 to about 80 μm. However, polymer microballoons having a diameter nearing 100 μm may become increasingly fragile due to the thinning of the shell material. In preferred approaches, an average diameter of the polymer microballoons is less than 100 μm.

An amount of polymer microballoons in the rubber mixture may be defined by the desired density of the rubber product. The amount of polymer microballoons may have an upper limit of about 60 vol. % of total mixture that results in a preferable packing fraction for a single size distribution of microballoons within a system. Ideally, the amount of polymer microballoons is tuned to allow the mixture to be free flowing without reaching a packing limit where the mixture is no longer free flowing. In one example, a 60 vol. % of polymer microballoons having a density of 0.03 g/cc may yield a density of the composition (e.g., formulation density) of about 0.44 g/cc.

The amount of polymer microballoons may have a lower limit of about 1 vol. % of total mixture to obtain a rubber material that is a little less dense than 1 g/cc. An amount of polymer microballoons may range from about 1 vol. % to about 60 vol. % of total rubber mixture. In another approach, polymer microballoons having a second distribution of smaller microballoons may represent a bimodal distribution that in turn may allow a higher packing limit of the polymer microballoons. Thus, in some approaches, the amount of polymer microballoons may be greater than 60 vol. % of total mixture (but below packing limit of the bimodal distribution of microballoons).

In some approaches, the resin composition may include starting materials having a relatively low molar mass and thus the resin has a low viscosity. A very low viscosity of the composition allows higher loading of pore formers such as polymer microballoons. In some approaches, it is desirable to have starting silicone precursors, e.g., polysiloxanes, having a lower viscosity as reasonably possible without being volatile, and still produce a rubber network. A low viscosity of the silicone precursors may be in a range of 1 to 200 centistokes (cSt). In one example, as illustrated in FIG. 1, the composition 100 of a resin may include a low molar mass of vinyl-terminated polysiloxane of about 6000 g/mol and having a viscosity of about 100 cSt. The polysiloxane may be blended with a silane crosslinker having a molar mass of about 2450 g/mol thereby producing a low viscosity fluid composition.

The composition of the RTV resin, including the starting siloxane monomers or oligomers, may have viscosities on the order of 2 to 200 Cp and may be considered to be a low viscosity resin base capable of accepting a high volume fraction of polymer microballoons. Moreover, the composition of the resin has a dynamic viscosity in a range of 2 to 200 centipoise (cP). Moreover, a resin having a low starting viscosity allows addition of a volume of polymer microballoons without altering the rheological behavior of the system to the extent that it rendered to a non-processable level.

According to one embodiment, formulation of the siloxane composition includes an additive for a stable suspension. In a typical fluid composition having 1 g/cc of silicone, the addition of a pore former, such as a polymer microballoon, results in a phase separation of pore former from the siloxane composition within a short time period, for example, the polymer microballoon may settle on the top of the suspension. Thus, the separation of the pore former from the siloxane composition disrupts the homogeneity of the formed material by de-stabilizing the suspension of the resin composition.

In one approach, the additive includes a thixotropic additive that functions as a stabilizer of the polymer microballoons in the suspension of the resin composition. The silicone polyether forms a fractal filler network with the polymer microballoons so that prior to the addition of a catalyst the resin composition is a static, shear thinning fluid that remains a stable suspension until the addition of the catalyst. The resin may remain a stable suspension for hours, days, etc. at room temperature.

As illustrated in FIG. 1, the thixotropic additive 106, e.g., a silicone polyether, is preferably a bridging amphoteric polyether having a structure similar to polysiloxane. Each molecule of the amphoteric polyether has a hydrophobic portion, a silicone portion, that has an affinity for the siloxane portion and becomes anchored in the polysiloxane of the composition. Each molecule of the amphoteric polyether also has a hydrophilic portion, a polyether co-polymer portion, of the molecule that is not miscible with the siloxane portion of the composition, and so has a strong interaction with the surface of the microballoon. The polyether portion may essentially adhere to the microballoon surface and the remaining portion of the silicone polyether dangles in the silicone matrix to secure the microballoon in the silicone matrix. Moreover, the polyether molecules form transient links between the surface of individual balloon particles, building bridges between two microballoons and building a bridge to another microballoon as well. The silicone polyether molecules preferably have a length that allows the molecule to attach to the surface of more than one microballoon. The silicone polyether molecule forms a “sticky bridge” between two microballoons with an anchor in the rubber matrix material.

A suspension of the composition having an amphoteric polyether spontaneously forms a transient fractal filler network where molecular bridges are formed between the microballoons in suspension. Thus, the microballoons cannot readily separate from each other and separate in the system. The bridging polyether functions as a suspension stabilizer for a solid particle and a liquid. Addition of the polymer microballoons to the composition comprising the amphoteric silicone polyether, the polyether acts as a bridging molecule between the polymer microballoons to form a transient fractal filler network, rendering the mixture to be a non-flowing, thixotropic (shear thinning) paste prior to catalyst addition.

Accordingly, a stabilized suspension that allows the microballoon pore former to remain in suspension over a duration of time is preferable. Moreover, stabilizing the microballoons in suspension allows the microballoons to remain evenly dispersed throughout the duration of the process of forming the material (e.g., via injection molding, transfer molding, etc.) and curing. In one approach, a composition includes an additive that functions to bridge the surface of the microballoons to the siloxane polymer in order to maintain an even dispersion of microballoons in the composition. In one preferred approach, the additive includes a bridging amphoteric polyether, e.g., silicone polyether.

A thixotrope additive, such as a silicone polyether, may be included in the composition at a loading in a range of about 0.3 to 2 wt. % on total mass of the composition.

For resin compositions having a low relative volume fractions of pore former, a second thixotropic additive may be included in the composition for stabilizing the network formation. In one approach, the composition may include a fumed silica. Preferably, a high surface area, fumed silica in a range of about 1 to 10 wt. % of the total mass of the composition may be blended in as an additional thixotropic additive to increase the efficiency of the physical network formation. Silica may be added to change the rheology of the siloxane resin. Preferably, the silica is a fumed silica having a high surface area. Silicas having a lower surface area, such as colloidal silica, crystalline silica, etc. are not preferable for modifying the viscosity of the formulation.

Silica may be added to increase the viscosity of the formulation. Moreover, the bridging amphoteric polyether molecules may also bridge the silica particles and the surfaces of the microballoons, and thus, the polyether molecules “gellify” the entire resin composition locking the microballoons in place in a fractal filler network that results in a significantly enhanced stability of the suspension gel-like suspension. In one approach, the application of a shear force (e.g., such as the force exerted on the resin during extrusion) breaks down the network under the force of shear, and the dispersion of the microballoons in the suspension remain intact.

In various approaches, the composition may be tailored to the amount of microballoons desired in the resin. For example, an amount of silica may be calculated according to a desired volume of microballoons in the resin suspension. The silica causes the suspension to remain in a gel-like state and more resistant to the shear force. For a composition having a lower concentration of microballoons, the formulation may be tailored by adding a greater concentration of silica to stabilize the system having a lower concentration of microballoons.

In one approach, for silicone matrix formulations having below 65 vol. % polymer microballoons, a stabilizer such as fumed silica may provide a stabilization of the suspension. For every vol. % of fumed silica added to the silicone matrix formulation, the viscosity of the formulation increases proportionally. For example, for low vol. % fractions of polymer microballoons such as 20 vol. % or lower to 1 vol. %, an amount of fumed silica may be added to the formulation to increase the viscosity of the formulation for efficient loading into molds. Approximately 5 to 20 wt. % fumed silica relative to the silicone resin (without polymer microballoons) may be added to the rubber matrix formulation to increase stability of the suspension, for formulations having 20 vol. % or less polymer microballoons.

In some approaches, the composition may include an additive for improving the mechanical properties of the rubber product. The additive may include a reinforcing filler, MQ resins, etc. However, the addition of fillers may reduce the optimal loading of the polymer balloon pore former for a given formulation.

A composition comprising the blended mixture of polysiloxane, silane crosslinker, thixotropic additive, and polymer microballoons is a stable suspension and may be stored at room temperature until use.

For many potential applications of the siloxane resin, platinum-mediated vinyl silane addition cured crosslinking processes offer an advantageous combination of activity, final rubber properties and process compatibility. According to one embodiment, a catalyst is added to the composition for the cure chemistries to crosslink the polysiloxane resin. According to one embodiment, a range of neutral cure compositions may be formulated based on a range of crosslinking chemistries. In various approaches, crosslinking chemistries may include, but are not limited to, platinum-, rhodium-, rhenium-mediated vinyl silane, addition or thiolene crosslinking, etc.

For example, as illustrated in FIG. 1, a neutral RTV cure of a composition of a siloxane resin, as described herein, may preferably include Platinum (Pt)-catalyzed final silane addition chemistry. A catalyst 114, preferably an Ashby-Karstedt catalyst that includes Pt, allows the desired curing chemistry and work times of the composition 100 and with the catalyst 114 for flowing the composition into the mold. The work times may range from 1 to 72 hours.

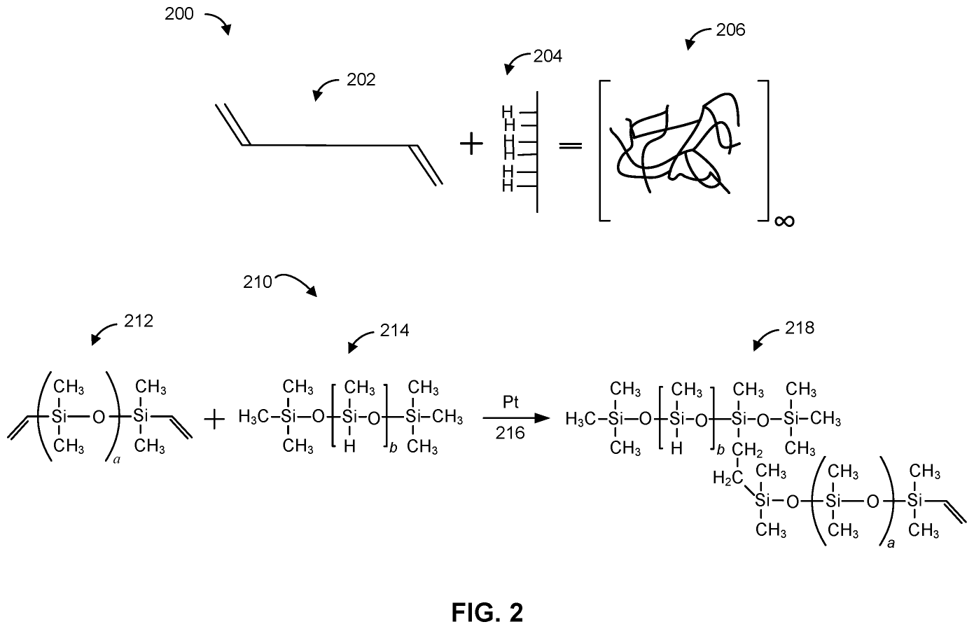

FIG. 2 illustrates one example of the curing crosslinking chemistry of the components of the resin. A basic diagram of the curing chemistry 200 includes the combination of the vinyl-terminated polysiloxane 202 with a silane crosslinker 204 to form an RTV rubber material 206. Looking more specifically at the chemistry involved, the catalyst reaction 210 of the composition includes a vinyl-terminated polysiloxane 212 having an a number of repeat siloxy groups and a silane crosslinker 214 having a b number of functional groups, preferably 3 or greater, in the presence of a Pt catalyst 216 for crosslinking the molecules together to form a RTV rubber material 218. The catalyst reaction 210 forms a Pt-mediated, addition cured, end linked vinyl-silane network.

The closed cell foam rubber may be formulated to have a uniform cured density from 0.35 to 0.95 g/cc while maintaining the ability to act as a self-leveling, shear thinning reactive fluid. The formulation of the composition (e.g., a resin) for forming a foam rubber may be configured to form a foam using molding techniques such as injection molding, transfer molding, etc. A resin for forming the foam rubber is preferably a fluid capable of rapid injection under force into a range of molds, cavities, forms, etc. The resin exhibits a high degree of gap-filling and resolution. The composition of the resin may be tuned to gel and cure over a range of timescales, e.g., from seconds to hours.

According to one embodiment, a product includes a material comprising a rubber, where the material has a homogenous density and a uniform porosity. The density of the rubber is in a range of greater than 0 g/cc and less than 1 g/cc. Preferably, the density of the rubber is in a range of about 0.35 g/cc to about 0.95 g/cc.

In one approach, the material has a shape corresponding to a mold. In another approach, the material has a shape corresponding to a template. In another approach, the material has a shape corresponding to a mask. In yet another approach, the material has a shape corresponding to a sacrificial form, e.g., a wax mold form, a cavity mold, etc.

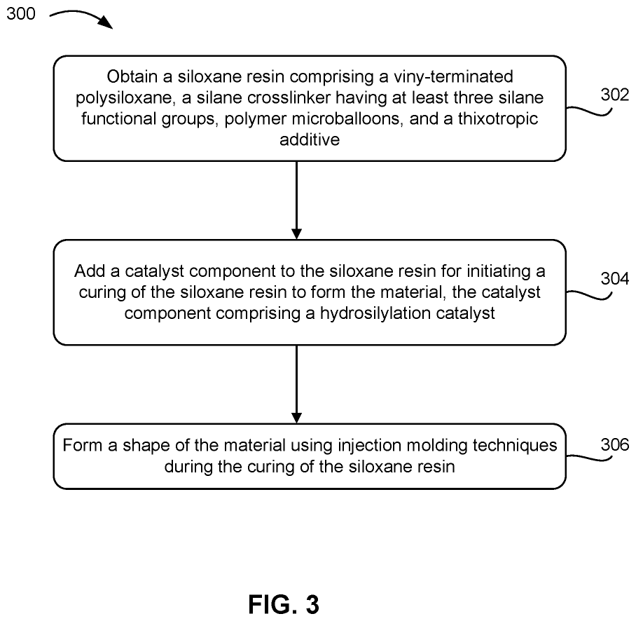

FIG. 3 shows a method 300 for forming a rubber product with homogenous density and uniform porosity, in accordance with one aspect of one inventive concept. As an option, the present method 300 may be implemented to construct structures such as those shown in the other FIGS. described herein. Of course, however, this method 300 and others presented herein may be used to form structures for a wide variety of devices and/or purposes which may or may not be related to the illustrative embodiments listed herein. Further, the methods presented herein may be carried out in any desired environment. Moreover, more or fewer operations than those shown in FIG. 3 may be included in method 300, according to various embodiments. It should also be noted that any of the aforementioned features may be used in any of the embodiments described in accordance with the various methods.

Operation 302 includes obtaining a siloxane resin as described herein. The siloxane resin includes a formulation of a composition that includes a siloxane polymer, a silane crosslinker having at least three silane functional groups, polymer microballoons, and a thixotropic additive. In one approach, a resin base may include the siloxane polymer, the polymer balloons, and the thixotropic additive (Component A). A second component, Component B, may include the silane crosslinker. Component A and Component B may be combined prior to using the resin. The combined Component A+B may be stored on a shelf until use. In some approaches where the resin is formed immediately prior to use, Component B may include the catalyst with the silane crosslinker.

Polymer microballoons may be added to the resin, crosslinker and thixotrope blend via a range of mixing methods, for example, using a paddle mixer, a pinch mixer, a vibratory mixer, a vortex mixer, a high shear mixer, a planetary mixer, a resonant acoustic mixing apparatus to form a homogeneous shear thinning thixotropic paste. In one approach, the polymer microballoons may be blended into the siloxane resin including the polysiloxane and silane crosslinker using a pinch mixer, and then the thixotropic additive and remaining components may be blended in the siloxane resin having the microballoons via a post-mixing step may include an overhead paddle to consolidate all the components in the silicone mixture. The viscosity of the mixture is preferably an optimal viscosity for storage (e.g., a “shaving cream/royal icing” type viscosity). The resin with polymer microballoons may be stored at this point as Component A+B.

Operation 304 of the method includes adding a catalyst component (Component C) to the siloxane resin for initiating a curing of the siloxane resin. The method includes a catalyst for coupling chemistry of the components of the siloxane resin. The catalyst is preferably added at a concentration in a range of about 5 to 25 ppm relative to the volume of the resin. In an exemplary approach, the catalyst is initially diluted into a small volume of the siloxane resin—a volume sufficient for homogenous mixing of the catalyst throughout the resin—before the addition of the catalyst to the entire volume of the siloxane resin. The catalyst component includes a hydrosilylation catalyst. The catalyst, Component C, may be mixed into the siloxane resin (Components A+B) with a paddle mixer and shaker, and the viscosity of the formulation will change into a free flowing fluid, that is ready to be used in an injection molding technique.

For each method utilized, the catalyst levels will require optimization to compensate for the effect of the mixing process on the level of balloon functionality exposure. The final uncatalyzed composition has a thixotrope package optimized of the balloon loading to ensure the suspension remains stable and does not phase segregate during storage. For the base example given here, and using commercial grades of Expancel® microballoons injection moldable silicone rubber compositions with densities ranging from 0.3 to 0.99 g/cc are readily achievable.

Mixed suspension stability during cure is achieved through the addition of the thixotrope and flowability during injection operations is maintained through the temporary, timed breakdown of the thixotropic fluid structure at the early stages of cure.

Cure schedules compatible with process operations (10-50 minutes to gelation) are attained through optimization of the catalyst loading in a defined ratio with the mole fraction of exposed chemical functionality on the polymer balloon surface for a given desired activity and target balloon loading. In a preferred method, a duration of time for the curing is in a range of about 30 minutes to 360 minutes at room temperature, where in the curing results in a complete cure of the material.

In some approaches of Pt-catalyzed RTV systems, polymer microballoons have been shown to have an inhibitory effect on hydrosilylation catalysts reactions of silicones. In particular, polymer microballoons having an acrylate-, acrylonitrile-, methacrylate-, etc.-based thermoplastic co-polymer surface have been observed to adversely affect (e.g., inhibit, significantly delay, etc.) the cure times of Pt-catalyzed addition cure silicones. In one example, siloxane resin having a gel time of less than 5 minutes at 4 ppm of Pt may be effectively inhibited to gel times of 12+ hours at room temperatures in the same siloxane resin loaded with polymer microballoons.

Without being held to a theory, it is believed that the thermoplastic shell of the polymer microballoons interact with the Pt center via a chelation effect, to inhibit the Pt reactivity. For example, the platinum metal center may be held by unsaturated functionalities of the thermoplastic shell that have an affinity for the Pt molecule and may bind the Pt species thereby inhibiting its reactivity for hydrosilylation. Applying heat to the system, above the glass transition of the microballoons, reverses the chelation effect, and the Pt molecules are then released to react and participate in the hydrosilylation chemistry.

In one approach, a thermal activation of the microballoon-loaded siloxane resin at temperatures more than 120° C. may drive the reaction to shorter time duration, however elevated temperatures are not always process compatible. For example, at a loading of Pt at 4 ppm, the curing is delayed until the composition is heated to 150° C., the curing of the composition proceeds rapidly.

Alternatively, simply increasing the concentration of the catalyst may mitigate the inhibitory effect the polymer microballoon, however for large volume operations, at a typical silane rich composition small thermal runaway effect can put the composition on a reactive knife-edge and lead to work, gel, and cure time instabilities. Additionally, minor gradients in relative balloon concentrations (top layers of a gravity mold, thin films and small gaps) become further inhibited and at low stable catalyst concentrations yielding long work times, these areas may suffer from under cure.

It is surprising that the polymer microballoons, e.g., Expancel®, demonstrate an inhibitory effect on the catalyst. However, the extended cure time may be advantageous for some manufacturing processes of rubber products. In the presence of polymer microballoons, the cure chemistry of the composition with a Pt catalyst is delayed thereby allowing an extended work time of using the composition until the catalyst effectively cures the composition. In the presence of a polymer microballoons, the Pt catalyst functions as a latent catalyst.

At room temperature, a composition of polysiloxane and silane crosslinker and without polymer microballoons is cured within about 5 minutes using a concentration of about 10 to 20 ppm Pt. However, a similar composition of polysiloxane and silane crosslinker with polymer microballoons has a significantly delayed cure time, not reaching a complete cure for up to 30 hours with the same concentration of 10 to 20 ppm Pt.

In one approach, increasing the concentration of Pt to about 40 to 80 ppm for a composition including polymer microballoons decreases the cure time to about five minutes. Alternatively, in another approach with a composition having polymer microballoons, increasing the temperature of the cure from RT to about 150° C. decreases the duration of time for the cure of the composition with polymer microballoons from 30 hours to around one hour.

In one exemplary approach, the composition with polymer microballoons includes a concentration of Pt in a range of 10 to 15 ppm, and preferably 12 to 13 ppm, for curing the composition at RT, thereby allowing a work time with the composition of about 2 hours (compared to 5 minutes for a composition that does not include polymer microballoons). In another approach, a composition without polymer microballoons having about 4 ppm Pt may cure in about 2 hours, and then with the addition of 4 ppm polymer microballoons, the composition (having 4 ppm Pt) has an extended cure time of 48 to 72 hours. The presence of polymer microballoons in a composition during Pt cure chemistry significantly extends the cure time duration.

The catalyst component may be optimized for work time, gel time, and cure time. In one approach, at a fixed silane to vinyl ratio (in this example 0.9:1) there is a relationship between gel time at a given temperature, the catalyst concentration and the mol fraction of functional surface from the polymer microballoons (polymer concentration effectively) at loadings of about 60 vol. % polymer microballoons about 12 ppm of Pt will yield a gel time of about 50 minutes at room temperature. Gel time decreases exponentially with temperature and Pt concentration. Gel time increases and decreases exponentially with increasing or decreasing polymer concentration. Therefore, for a given desired polymer sphere loading at a given temperature of process, the concentration of Platinum is selected to yield a work, a gel, and a cure time compatible with the process. The extent of shearing of the microballoons to some extent allows increases in the relative fraction of functionality available to chelate and inhibit the platinum and shear rate or total mix. Energy of the complete composition may be utilized as a means of moderating work times (e.g., high shear rates for extended periods=longer work times). However, in most practical processes, it is a complex variable to control and should therefore remain fixed.

According to one embodiment, a solution includes both the runaway instability and the under cure to take the crosslinking reaction out of silane excess and balance the stoichiometry such that a small excess of vinyl groups remain on full cure. This moderates the rate of the crosslinking reaction as the active silane-Pt complex is formed at a lower concentration and allows the inclusion of higher concentrations of Platinum catalyst, e.g., 10-15 ppm, which allows even high concentration balloon regions to polymerize fully and renders the system less susceptible to runaway instability.

In some approaches, alternate catalysts such as rhenium complexes have the potential to mitigate, however their specific activity is lower than Platinum. The use of alternate crosslinking chemistries is a mitigation such as thiolene chemistry, however these may not always be process or materials compatible, therefore it is advantageous and desirable to allow the controlled used of Platinum addition cure processes in this invention.

In preferred approaches of a nominal rubber composition having a Pt-mediated vinyl-silane reaction, the stoichiometry of vinyl groups to silane groups to be in vinyl excess. In an exemplary approach, a ratio of vinyl to silane functional groups in the composition may be no more than 10% excess of vinyl to silane functional groups. In one example, the vinyl to silane ratio in the composition is 1:0.9 V:Si—H.

In conventional siloxane crosslinking chemistries, the generally understood rule is to have a silane excess such that the vinyl to silane functional group ratio is in a range of 1.5 and 1.75 silane for each vinyl (e.g., 1:1.5-1.75 V:Si—H). Formation of a platinum-silane complex is generally understood to effectively drive the reaction forward to completion. However, shifting the ratio to more vinyl than silane, the presence of excess vinyl groups slow down the reaction by inhibiting the formation of the platinum-silane complex. According to the composition described herein, since the platinum (Pt) loading is high to account for the inhibitory effect of the Pt with the polymer microballoons, the ratio of vinyl to silane is preferably adjusted such that the silane concentration is not in excess in order to control the rate of the reaction more effectively (e.g., control the reaction from accelerating to completion). Preferably, the rate of reaction of the composition, e.g., the pot life of the reaction, remains stable to allow completion of the injection molding process before complete cure of the composition. In preferred approaches, a slight vinyl excess to silane allows control of the reaction and prevents the reaction prematurely accelerating to completion. The reaction rate is stabilized with a slight excess of vinyl to silane ratio.

In a preferred approach, the composition of the resin includes an amount of vinyl-terminated polysiloxane having vinyl functional groups and an amount of silane crosslinker having silane functional groups such that the ratio of vinyl to silane is about 1.1 vinyl to 0.9 silane (V:Si—H), where there is about a 10% increase in vinyl excess and a 10% decrease in silane.

Alternatively, in situations where an extended duration at room temperature of the pot-lives and work times are sought and elevated temperature cures are compatible with a process, the in-built latency of a low Pt concentration and the polymer microballoons may be considered an advantageous feature of this invention with the balloon filler acting as an active and efficient inhibitor of the catalyst. In one approach, the catalyst reaction, and effective curing time, may be readily activated at temperatures in excess of 120° C. In another approach, the catalyst reaction, and effective curing time, may be readily activated using increased concentrations of the catalyst in the formulation to overcome the inhibitory effect of the polymer microballoons.

Operation 306 includes forming the product using injection molding techniques with the curing siloxane resin.

Injection molding processes typically have partially, or semi-closed volume, e.g., a two piece mold that has multiple injection points with ports for removing air, or pulling the material in via vacuum. The material is tuned for the size of the cavity to be filled, the diameter of the ports for adding the material, etc. Moreover, injection molding uses an in-line continuous or static agitator mixer to the components A, B, and C during injection. The extended work time allows time to fill the mold with the material.

Transfer molding operations are similar, however comprise lower overall volume molds or less complex geometries, where a smaller volume of pre-mixed material is transferred to the cavity mold in a batch process. The extended work time allows time for preparing the material and transferring the pre-mixed material into a vessel for transferring to a mold.

In various approaches, the mixed catalysis reactions induce thixotropic transitions in the resin formulation thereby allowing processability and post injection suspension stabilization. Moreover, the resin formulation improves performance as a low-density injection molding foam/encapsulant/potting composition.

In an exemplary approach, a rubber material is formed from a composition having a low density of about 0.5 g/cc with a homogenous distribution of microballoon pore former. In addition, the composition has a viscosity that resembles “shaving cream” and is a good form filler for moldability, however, the viscosity of the material is less desirable for injection molding processes.

It was surprising, therefore, that the curing process using coupling chemistry transformed the composition having a viscosity resembling shaving cream to a composition having a viscosity resembling a free-flowing fluid. The curing process is exothermic and, where the catalyst, e.g., platinum, rhodium, rhenium, etc., reacts with the polysiloxane composition, so the material heats up during curing. In the case of using a Pt catalyst with a silane crosslinker, the Pt-silane intermediates that form at the start of the reaction have a slightly different chemical potential compared to the base material, so without wishing to be bound by a theory, it is believed the temperature and the early stage reaction changes both conspire to collapse the pre-existing rheology of the system temporarily and disrupt the fractal cellular network (“shaving cream”-type structure). Thus, when the composition (Components A+B) is catalyzed by the addition of the catalyst component (Component C), the remarkable result occurs where the viscosity of the suspension (e.g., shaving cream, royal icing-type structure) at about a loading viscosity of 10 Pas changes to a loading viscosity of about 8 Pas for a 0.5 g/cc system. A resin having a loading viscosity of about 8 Pa·s may be characterized as a quasi-Newtonian fluid a composition that can be pushed through a pressure port, a syringe, injection molding, etc.

Furthermore, over the course of the reaction of the curing process, as the polymer network starts to form and gel, the rheology changes again and the material becomes less free-flowing so that the phase separation of the microballoons is inhibited. The material undergoes a classic gelation process, continues curing, and becomes a solid, fully-cured material.

In the invention described here, the final composition is highly processable post catalysis which enables large cavity volumes with complex features including narrow gaps and knife-edges to be filled with minimal void entrapment and high fidelity. For an exemplary formulation described herein, large, closed volumes on the order of ˜6000 cc with complex features may be filled in approximately 4 minutes at a force of 35 psi through a port with an air vent, with minimal void entrapment and extremely high feature resolution.

### Experiments

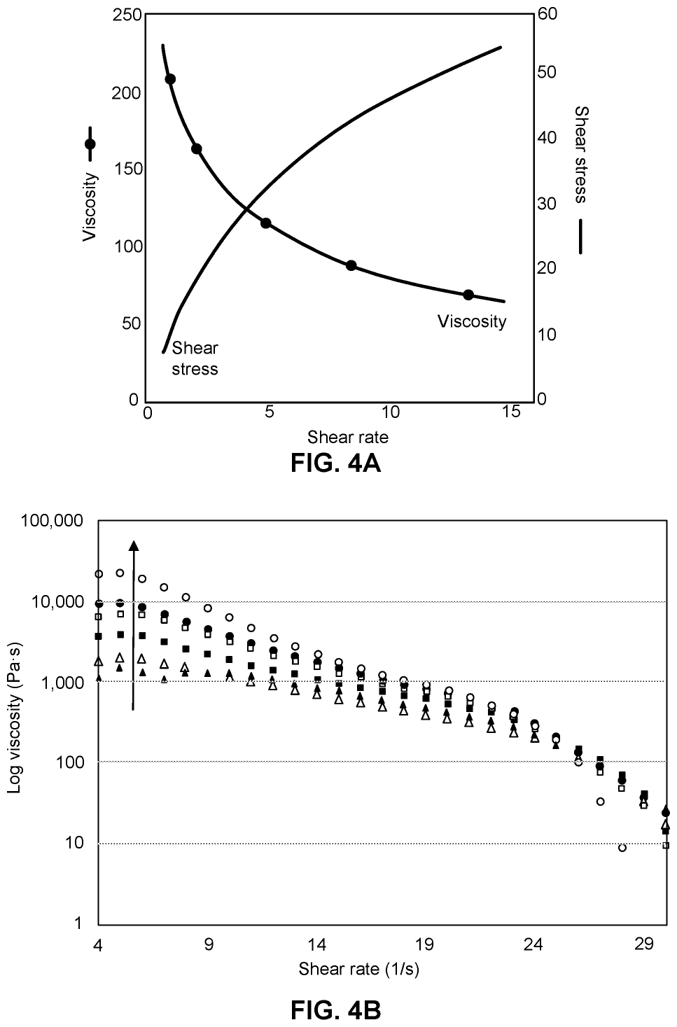

FIG. 4A shows a plot of a shear thinning fluid that illustrates a rheological description of a “shaving cream”-type viscosity such that increasing the applied stress (shear rate) by pushing something more, something harder, the dynamic viscosity drops, and thereby facilitating the fluid to be pushed through a tube.

According to one approach, shear stress versus shear rate of the resin changes during the formation process. The uncatalyzed siloxane resin, Components A+B, comprising siloxane polymer, silane crosslinker, thixotropic additive and the polymer balloons has the shear stress vs. shear rate characteristic of a pseudoplastic material. Addition of the catalyst (Component C to Components A+B) for the approximately first 10 minutes of cure (e.g., catalyst reaction) changes the resin into a free-flowing quasi-Newtonian fluid. Within 20 minutes of Gel-time, free-flowing fluid changes back toward pseudoplastic behavior with an exponential increase in dynamic viscosity.

FIG. 4B illustrates a plot of the increasing viscosity of a resin that has increasing loadings of microballoons as a function of shear rate. The increase in shear rate results in a decrease in viscosity. Each formulation represented by a symbol has a higher amount of microballoons in the direction of the arrow (e.g., ∘ having the highest amount of microballoons and ▴ having the lowest amount of microballoons). It was noted that the formulation having the highest amount of microballoons (∘) demonstrated a remarkable change in viscosity in response to increasing applied stress.

In one example, the curing of the formulation may include an initial 20 minutes of gel time where the formulation is workable as the viscosity increases significantly, at 45 minutes the gel fills in the cracks, crevices, features of the mold, and then up to 2 hours, the formulation cures completely. The gel point is when the formulation is no longer a fluid becoming a jellied rubber.

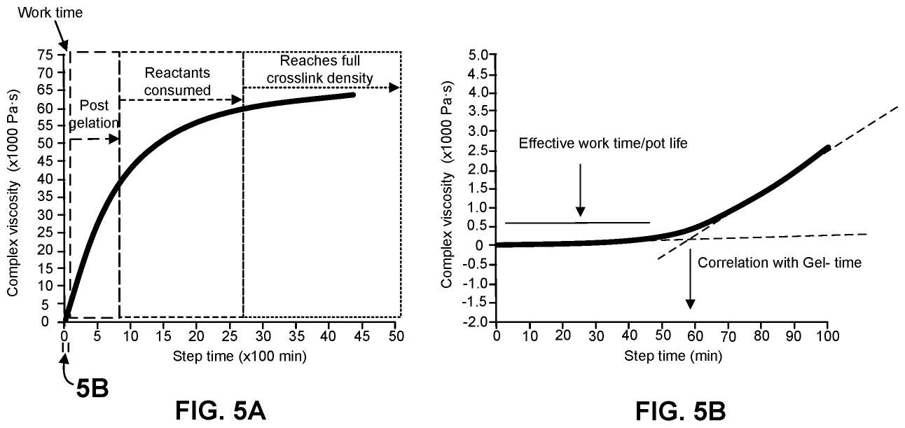

As shown in FIG. 5A, the work time, the optimal time to inject the resin into the mold at the very start is the beginning linear portion of the curve. In the example illustrated in FIG. 5A, the first 100 minutes represent the work time. As shown in this example, a near linear increase in apparent viscosity of the material occurs for an extended period of time, such as the first 700 minutes. The progression of the material to full cure extends to approximately 72 hours (4,320 minutes) of step time which represents the material achieving the desired mechanical properties associated with a complete full cure. FIG. 5B illustrates a magnified view of the work time within the first 100 minutes of the catalyst being added to the resin, the curing time. The cross-over point here (intersection of dashed lines), approximately 60 minutes, is the point at which the material gels, the crossover between the real and imaginary component of the complex modules. The action tends to slow down as the molecular mobility slows down, the material meets the mechanical properties of full cure. The effective work-time/pot-life of the formulation is within the first 60 minutes after the catalyst has been added to the composition.

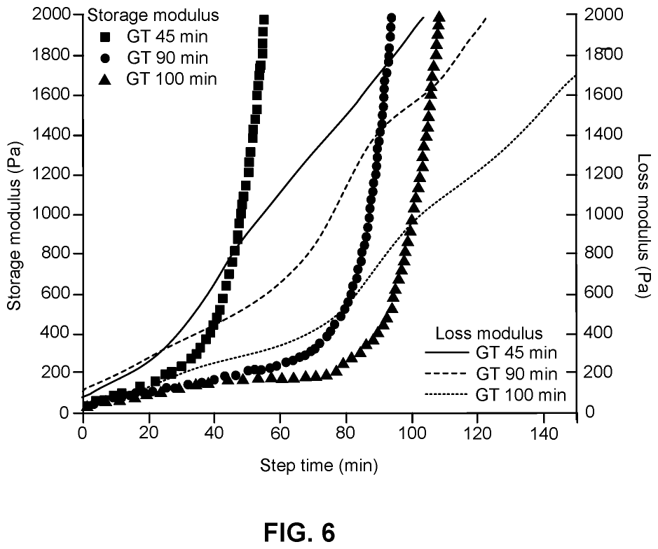

FIG. 6 represents a plot of the stress to strain (G′/G″ (storage modulus/loss modulus)) of three formulations of a composition. From this comparison, the gel-time of each composition may be determined as the G′-G″ crossover to be 45 minutes (▪, solid line), 90 minutes (∘, long dash line), and 100 minutes (▴, short dash line). These data show the ability to vary the gel-time of the system to provide a range of work times for molding operations.

### In Use

Various aspects of an inventive concept described herein may be developed for electronics encapsulation, gap-filling, potting of components, ballast, thermal insulation, structural lightweighting, sporting goods, etc.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept, but should be defined only in accordance with the following claims and their equivalents.

What is claimed is:

1. A composition of a resin for room temperature vulcanizable rubber, the composition comprising:
a polysiloxane with vinyl and/or silanol reactive functionality of at least 2;
a crosslinker reactive toward vinyl and/or silanol functionality;
polymer microballoons; and
a thixotropic additive.

2. The composition as recited in claim 1, wherein the composition further comprises a catalyst selected from the group consisting of: a platinum catalyst, a rhodium catalyst, and a rhenium catalyst.

3. The composition as recited in claim 1, wherein the polysiloxane is selected from the group consisting of: a vinyl-terminated polysiloxane, a thiol-ene terminated polysiloxane, a dimethyl siloxane, a di-phenyl siloxane, an ethyl, methyl siloxane, a diethyl siloxane, a polydimethylsiloxane-polyvinylmethylsiloxane copolymer, a tetra-functional polysiloxane, and a tri-functional polysiloxane.

4. The composition as recited in claim 1, wherein the polysiloxane has a low molar mass in a range of greater than 200 g/mol to about 10,000 g/mol.

5. The composition as recited in claim 1, wherein the crosslinker is a silane crosslinker having at least three silane functional groups.

6. The composition as recited in claim 5, wherein a ratio of vinyl to silane functional groups in the composition is no more than 10% excess of the vinyl to the silane functional groups.

7. The composition as recited in claim 1, wherein the crosslinker is a thiol and/or thiolene crosslinker having at least three functional groups.

8. The composition as recited in claim 1, wherein the crosslinker is an alkoxy blocked silane.

9. The composition as recited in claim 1, wherein the thixotropic additive is an amphoteric polyether.

10. The composition as recited in claim 1, wherein a viscosity of the composition is in a range of 20 to 1000 centistokes.

11. The composition as recited in claim 1, further comprising a fumed silica.

12. The composition as recited in claim 1, wherein the composition is configured to form a foam using molding techniques.

13. The composition as recited in claim 1, wherein the polymer microballoons are expanded gas-filled microballoons having a thermoplastic shell.

14. The composition as recited in claim 1, wherein the polymer microballoons have a density in a range of greater than 0.01 g/cc to less than 0.5 g/cc.

15. A product, comprising:
a material comprising a rubber, wherein the material has a homogenous density and a uniform porosity,
wherein the density is less than 1 gram per cubic centimeter (g/cc).

16. The product as recited in claim 15, wherein the material has a shape corresponding to a mold.

17. The product as recited in claim 15, wherein the density is in a range of 0.35 to 0.95 g/cc.

18. A method of forming the product as recited in claim 15, the method comprising:
obtaining a siloxane resin comprising:
a vinyl-terminated polysiloxane,
a silane crosslinker having at least three silane functional groups,
polymer microballoons, and
a thixotropic additive;
adding a catalyst component to the siloxane resin for initiating a curing of the siloxane resin to form the material, the catalyst component comprising a hydrosilylation catalyst; and
forming a shape of the material using injection molding techniques during the curing of the siloxane resin.

19. The method as recited in claim 18, wherein the catalyst component is present in an amount in a range of 5 to 25 parts per million in the siloxane resin.

20. The method as recited in claim 18, wherein a duration of time of the curing is in a range of 30 minutes to 360 minutes.

21. The method as recited in claim 18, wherein a ratio of vinyl to silane functional groups in the siloxane resin is no more than 10% excess of the vinyl to the silane functional groups.
